(19) United States
(12) Patent Application Publication
(10) Pub. No.: US 2011/0302915 A1
(43) Pub. Date: Dec. 15, 2011

(54) HYDRAULIC PRESSURE CONTROL DEVICE

(75) Inventors: Tetsuya SHIMIZU, Anjo-shi (JP); Tomoya JINNO, Nishio-shi (JP); Kenichi TSUCHIDA, Nishio-shi (JP); Naoyuki FUKAYA, Okazaki-shi (JP); Kazunori ISHIKAWA, Toyota-shi (JP)

(73) Assignee: AISIN AW CO., LTD., Anjo-shi (JP)

(21) Appl. No.: 13/157,027

(22) Filed: Jun. 9, 2011

(30) Foreign Application Priority Data
Jun. 11, 2010 (JP) 2010-134392

(51) Int. Cl. F16D 31/02

(52) U.S. Cl. 60/464

(57) ABSTRACT

A hydraulic pressure control device including a valve for generating a circulating pressure to a hydraulic power transmission chamber in which power is transmitted between an input- and output side of a hydraulic power transmission element via hydraulic oil; and a valve for generating a lock-up pressure supplied to a lock-up chamber that faces the hydraulic power transmission chamber with a lock-up piston included in a lock-up clutch interposed therebetween. The hydraulic pressure control device controls the hydraulic pressures in the hydraulic power transmission chamber and in the lock-up chamber; and the circulating pressure valve has a spool to which the circulating pressure is applied as a feedback pressure and another hydraulic pressure is applied when the lock-up clutch is engaged/disengaged, and a spring urges the spool, and sets the circulating pressure to a constant first pressure when the lock-up clutch is disengaged and to a constant second different pressure when the lock-up clutch is engaged, depending on forces to the spool by the feedback pressure and on the spring.

### INCORPORATION BY REFERENCE

The disclosure of Japanese Patent Application No. 2010-134392 filed on Jun. 11, 2010 including the specification, drawings and abstract is incorporated herein by reference in its entirety.

### BACKGROUND OF THE INVENTION

The present invention relates to a hydraulic pressure control device that controls the hydraulic pressure in a hydraulic power transmission chamber in which power is transmitted between an input-side hydraulic power transmission element and an output-side hydraulic power transmission element via hydraulic oil, and a hydraulic pressure in a lock-up chamber that faces the hydraulic power transmission chamber with a lock-up piston included in a lock-up clutch interposed therebetween.

### DESCRIPTION OF THE RELATED ART

As hydraulic pressure control devices of a type as described above, there have conventionally been proposed hydraulic pressure control devices for an automatic transmission that have a linear solenoid valve outputting a control pressure according to a throttle opening, a primary regulator valve regulating a line pressure according to the control pressure, and a secondary regulator valve generating, according to the control pressure from the linear solenoid valve, a secondary pressure that is lower than the line pressure, and supply the secondary pressure to a lock-up clutch and a torque converter (for example, refer to Japanese Patent Application Publication No. JP-A-2006-349007). The secondary regulator valve of the hydraulic pressure control device disclosed in Japanese Patent Application Publication No. JP-A-2006-349007 has a spool having a large diameter portion provided on one side in the axial direction thereof and a small diameter portion provided on the other side in the axial direction thereof, a first oil chamber to which the control pressure is applied from an end portion on the other side in the axial direction of the spool, a second oil chamber to which a feedback pressure of the secondary pressure is applied from an end portion on the one side in the axial direction of the spool, and a third oil chamber that is provided between the large diameter portion and the small diameter portion of the spool and is supplied with the line pressure when the lock-up clutch is engaged, and so as to make the secondary pressure higher when the line pressure is supplied to the third oil chamber than when the line pressure is not supplied to the third oil chamber.

In the hydraulic pressure control device structured as described above, when the lock-up clutch is released, the line pressure is not supplied to the third oil chamber of the secondary regulator valve, which generates the secondary pressure according to the control pressure applied to the first oil chamber and the feedback pressure applied to the second oil chamber, and supplies the secondary pressure to the torque converter. On the other hand, when the lock-up clutch is engaged, the line pressure is supplied to the third oil chamber, and thereby the secondary regulator valve generates a higher secondary pressure than that generated when the lock-up clutch is released. Then, when the lock-up clutch is engaged, the secondary pressure generated by the secondary regulator valve is supplied into the torque converter after being depressurized by a check valve having a plunger and a spring, while the secondary pressure generated by the secondary regulator valve is supplied to the lock-up clutch via a lock-up control valve.

### SUMMARY OF THE INVENTION

However, because the check valve has only a low pressure-regulating capability and also because the pressure of hydraulic oil changes depending on the temperature of the hydraulic oil, it is difficult to appropriately adjust the hydraulic pressure in the torque converter by using the check valve when the lock-up clutch is engaged. In order to perform the engagement process of the lock-up clutch smoothly, a necessity arises for finely controlling the linear solenoid valve according to the temperature of the hydraulic oil. In addition, in the conventional hydraulic pressure control device described above, it is also necessary to similarly take into account the temperature of the hydraulic oil when the hydraulic pressure in the torque converter is adjusted while the lock-up clutch is disengaged.

Therefore, it is a primary objective of the present invention to provide a hydraulic pressure control device that more appropriately sets the hydraulic pressure in a hydraulic power transmission chamber in which power is transmitted by hydraulic power transmission elements via hydraulic oil, without using complicated control.

In order to achieve the primary objective described above, the hydraulic pressure control device of the present invention employs the following means.

According to a first aspect of the present invention, a hydraulic pressure control device includes: a circulating pressure setting valve that generates a circulating pressure serving as a hydraulic pressure supplied to a hydraulic power transmission chamber in which power is transmitted between an input-side hydraulic power transmission element and an output-side hydraulic power transmission element via hydraulic oil; and a lock-up pressure generating valve that generates a lock-up pressure supplied to a lock-up chamber that faces the hydraulic power transmission chamber with a lock-up piston included in a lock-up clutch interposed therebetween, and controls the hydraulic pressures in the hydraulic power transmission chamber and in the lock-up chamber. In the hydraulic pressure control device, the circulating pressure setting valve has a spool to which the circulating pressure is applied as a feedback pressure and another hydraulic pressure is applied in addition to the feedback pressure when the lock-up clutch is engaged or disengaged, and a spring that urges the spool, and sets the circulating pressure to a constant first pressure when the lock-up clutch is disengaged and to a constant second pressure different from the first pressure when the lock-up clutch is engaged, depending on the force given to the spool by the application of the feedback pressure and on the urging force given from the spring to the spool.

The circulating pressure setting valve of the hydraulic pressure control device according to the first aspect has the spool to which the circulating pressure is applied as a feedback pressure and another hydraulic pressure is applied in addition to the feedback pressure when the lock-up clutch is engaged or disengaged, and the spring that urges the spool, and sets the circulating pressure to the constant first pressure when the lock-up clutch is disengaged and to the constant second pressure different from the first pressure when the lock-up clutch is engaged, depending on the force given to the spool by the application of the feedback pressure and on the urging force given from the spring to the spool. According to the first aspect, the circulating pressure can be set to the constant first or second pressure in a stable manner when the lock-up clutch is either disengaged or engaged, and the necessity is eliminated to finely control the linear solenoid valve, etc. according to the temperature of the hydraulic oil. In addition, by providing a different amount of the circulating pressure between when the lock-up clutch is disengaged and when it is engaged, the circulating pressure when the lock-up clutch is engaged can be a pressure in accordance with the mode of generation of the lock-up pressure by the lock-up pressure generating valve. Therefore, with the hydraulic pressure control device according to the first aspect, it is possible to more appropriately set the hydraulic pressure in the hydraulic power transmission chamber in which power is transmitted between the input-side hydraulic power transmission element and the output-side hydraulic power transmission element via hydraulic oil, without using complicated control.

According to a second aspect of the present invention, the lock-up pressure generating valve may generate the lock-up pressure so as to be higher than the circulating pressure when the lock-up clutch is engaged, and the other hydraulic pressure may be applied to the spool of the circulating pressure setting valve so that the spring is compressed more when the lock-up clutch is disengaged than when the lock-up clutch is engaged. According to the second aspect, when the lock-up clutch is disengaged, the circulating pressure is set to the first pressure that is higher, by an amount obtained by compression of the spring, than the second pressure that is set when the lock-up clutch is engaged. Therefore, when the lock-up clutch is disengaged, cavitation can be suppressed from occurring in the hydraulic power transmission chamber by keeping the pressure in the hydraulic power transmission chamber at a high level to a certain extent. When the lock-up clutch is engaged, the circulating pressure is set to the second pressure that is lower than the first pressure. Therefore, when the lock-up clutch is engaged, both of the circulating pressure and the lock-up pressure supplied for engaging the lock-up clutch can be reduced, thereby reducing the source pressures of both pressures. Note that, if the lock-up pressure generating valve generates the lock-up pressure so as to be lower than the circulating pressure when the lock-up clutch is engaged, the other hydraulic pressure may be applied to the spool of the circulating pressure setting valve so that the spring is compressed more when the lock-up clutch is engaged than when the lock-up clutch is disengaged.

According to a third aspect of the present invention, the hydraulic pressure control device may further include a relay valve that supplies the circulating pressure from the circulating pressure setting valve to the hydraulic power transmission chamber regardless of the engagement state of the lock-up clutch, and supplies the circulating pressure to the circulating pressure setting valve when the lock-up clutch is disengaged, and the circulating pressure from the relay valve may be applied as the other hydraulic pressure to the spool of the circulating pressure setting valve when the lock-up clutch is disengaged. According to the third aspect, when the lock-up clutch is engaged, the circulating pressure setting valve sets the circulating pressure to the first pressure that is higher than the second pressure by using the feedback pressure and the circulating pressure from the relay valve. Therefore, the circulating pressure can be set to the first pressure that is higher than the second pressure without increasing the line pressure more than necessary when the lock-up clutch is disengaged.

Moreover, according to a fourth aspect of the present invention, the spool of the circulating pressure setting valve may be arranged in a slidable manner in an axial direction in a valve hole formed in a valve body, and may have at least two lands provided at an axial distance from each other; the spring of the circulating pressure setting valve may be arranged such that one end thereof comes in contact with the spool and another end thereof comes in contact with a plunger arranged in a slidable manner in the axial direction in the valve hole; a pressure regulating chamber for regulating the circulating pressure may be defined by the valve body and the two lands of the spool, the pressure regulating chamber being communicable with an input port, an output port, and a drain port formed in the valve body; a first oil chamber to which the circulating pressure output from the output port is supplied as the feedback pressure may be defined so as to face the plunger with the two lands of the spool interposed therebetween; and a second oil chamber to which the circulating pressure from the relay valve is supplied may be defined so as to face the spring with the plunger interposed therebetween. According to the fourth aspect, it is possible to set the circulating pressure to the first pressure when the lock-up clutch is disengaged, and to the second pressure when the lock-up clutch is engaged, without using complicated control while making the structure of the circulating pressure setting valve relatively simple. By improving arrangement of ports and oil passages of the valve body, shapes of separator plates, and the like, in addition to structuring the circulating pressure setting valve as described above, it is possible to easily structure a regulator valve that generates a hydraulic pressure according to a signal pressure from the linear solenoid valve, by changing the spool and the spring arranged in the valve hole of the valve body.

Furthermore, according to a fifth aspect of the present invention, the hydraulic power transmission chamber may have a hydraulic oil inlet through which the circulating pressure is supplied from the relay valve, and a hydraulic oil outlet for discharging the hydraulic oil; the relay valve may have a discharged oil inflow port connected to the hydraulic oil outlet of the hydraulic power transmission chamber and three discharged oil outflow ports, and communicate the discharged oil inflow port with one of the three discharged oil outflow ports when the lock-up clutch is disengaged while communicating the discharged oil inflow port with two discharged oil outflow ports other than the one of the three discharged oil outflow ports when the lock-up clutch is engaged; and the lock-up pressure generating valve may have an inflow port connected to one of the two discharged oil outflow ports of the relay valve, and an outflow port, and communicate the inflow port with the outflow port until the lock-up clutch is fully engaged and cut off the communication between the inflow port and the outflow port when the lock-up clutch is fully engaged. According to the fifth aspect, when the lock-up clutch is fully engaged, unnecessary consumption of hydraulic oil can be suppressed by reducing the amount of discharge of the hydraulic oil from the hydraulic power transmission chamber, that is, the flow rate of the hydraulic oil circulating in the hydraulic power transmission chamber.

In addition, the lock-up clutch may be a multi-plate clutch.

### BRIEF DESCRIPTION OF THE DRAWINGS

FIG. 1 is a schematic diagram of an automobile 10 serving as a vehicle equipped with a power transmission device 20 containing a hydraulic pressure control device 50 according to an embodiment of the present invention;

FIG. 2 is a schematic diagram of the power transmission device 20;

FIG. 3 is an operation table indicating the relationship between each shift speed and operating states of the clutches and the brakes in an automatic transmission 40 contained in the power transmission device 20;

FIG. 4 is a system diagram showing an essential part of the hydraulic pressure control device 50; and

FIG. 5 is a schematic diagram showing an essential part of a hydraulic pressure control device 50B that shares parts, such as a valve body, with the hydraulic pressure control device 50.

### DETAILED DESCRIPTION OF THE EMBODIMENTS

Next, modes for carrying out the present invention will be described by using embodiments.

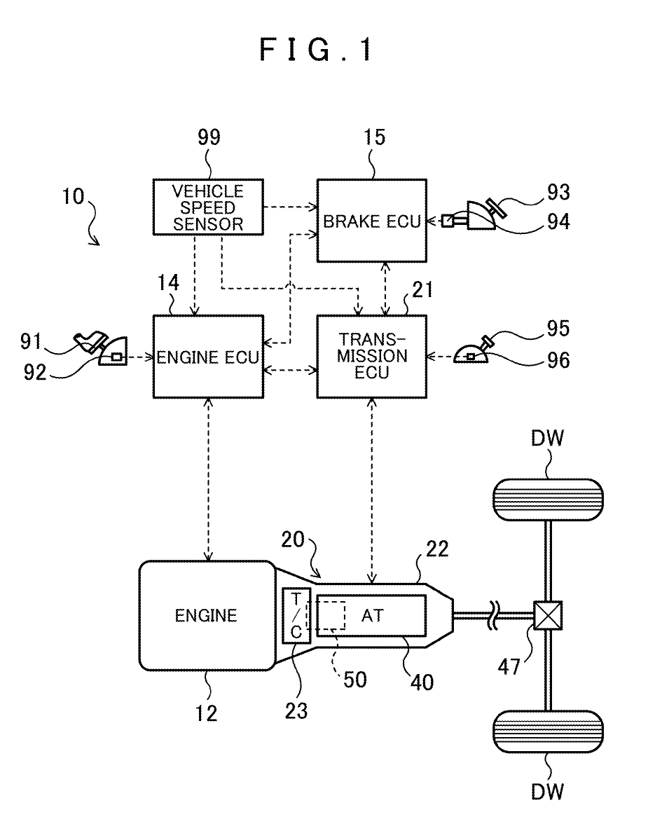

FIG. 1 is a schematic diagram of an automobile 10 serving as a vehicle equipped with a power transmission device 20 containing a hydraulic pressure control device according to an embodiment of the present invention. The automobile 10 shown in FIG. 1 has an engine 12 serving as an internal combustion engine that outputs power by explosive combustion of a mixture of air and hydrocarbon-based fuel such as gasoline or diesel oil, an engine electronic control unit (hereinafter called an “engine ECU”) 14 that controls operation of the engine 12, and a brake electronic control unit (hereinafter called a “brake ECU”) 15 that controls an electronically controlled hydraulic brake unit (not shown). The automobile 10 is also equipped with the power transmission device 20 that has a torque converter 23 serving as a hydraulic transmission apparatus, a stepped automatic transmission 40, a hydraulic pressure control device 50 that supplies and discharges hydraulic oil (working fluid) to and from the torque converter 23 and the automatic transmission 40, and a transmission electronic control unit (hereinafter called a “transmission ECU”) 21 that controls the torque converter 23, the automatic transmission 40, and the hydraulic pressure control device 50. The power transmission device 20 is connected to a crankshaft 16 of the engine 12 serving as a motor, and transmits the power from the engine 12 to left and right driving wheels DW.

As shown in FIG. 1, the engine ECU 14 is supplied with an accelerator operation amount Acc from an accelerator pedal position sensor 92 that detects a depressed amount (operation amount) of an accelerator pedal 91, a vehicle speed V from a vehicle speed sensor 99, signals from various sensors such as a crankshaft position sensor (not shown) that detects rotation of the crankshaft 16, and signals from the brake ECU 15 and the transmission ECU 21. Based on these signals, the engine ECU 14 controls an electronically controlled throttle valve, fuel injection valves, spark plugs, and the like (all not shown). The brake ECU 15 is supplied with a master cylinder pressure detected by a master cylinder pressure sensor 94 when a brake pedal 93 is depressed, the vehicle speed V from the vehicle speed sensor 99, signals from various sensors (not shown), and signals from the engine ECU 14 and transmission ECU 21. Based on these signals, the brake ECU 15 controls a brake actuator (hydraulic actuator) and the like (not shown).

The transmission ECU 21 of the power transmission device 20 is housed inside the transmission case 22. The transmission ECU 21 is supplied with a shift range SR from a shift range sensor 96 that detects an operating position of a shift lever 95 for selecting a desired shift range from a plurality of shift ranges, the vehicle speed V from the vehicle speed sensor 99, signals from various sensors (not shown), and signals from the engine ECU 14 and the brake ECU 15. Based on these signals, the transmission ECU 21 controls the torque converter 23, the automatic transmission 40, and the like. Note that each of the engine ECU 14, the brake ECU 15, and the transmission ECU 21 is structured as a microprocessor that is mainly composed of a CPU (not shown), and is provided with a ROM that stores processing programs, a RAM that temporarily stores data, input and output ports, and a communication port (all not shown) in addition to the CPU. The engine ECU 14, the brake ECU 15, and the transmission ECU 21 are connected to each other via bus lines, etc. Thus, these ECUs exchange data required for control with each other as needed.

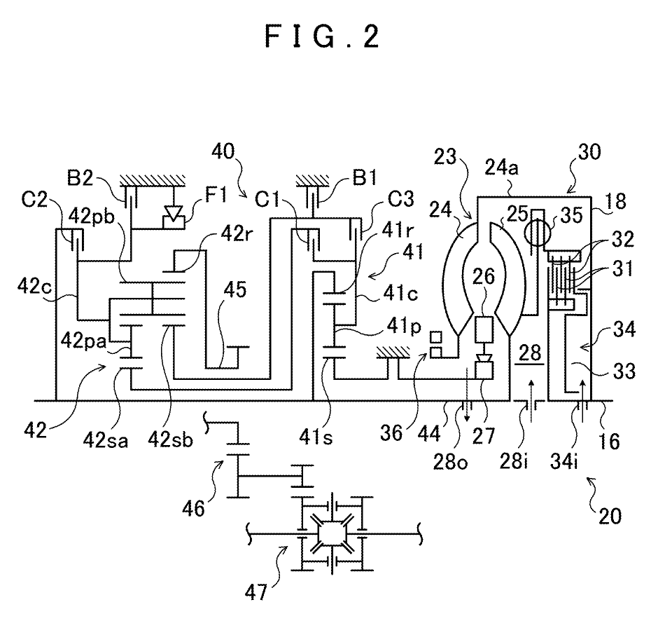

The power transmission device 20 includes the torque converter 23, an oil pump 36, the automatic transmission 40, etc. that are housed in the transmission case 22. The torque converter 23 is structured as a hydraulic torque converter with a lock-up clutch, and as shown in FIG. 2, includes a pump impeller 24 that is connected to the crankshaft 16 of the engine 12 via a front cover 18, a turbine runner 25 that is fixed to an input shaft (input member) 44 of the automatic transmission 40 via a turbine hub, a stator 26 that is arranged on the inside of the pump impeller 24 and the turbine runner 25 and straightens the flow of the hydraulic oil (ATF) from the turbine runner 25 to the pump impeller 24, and a one-way clutch 27 that limits the rotation of the stator 26 in one direction. The pump impeller 24, the turbine runner 25, and the stator 26 form a torus (annular flow passage) to circulate the hydraulic oil in a hydraulic power transmission chamber 28 that is defined by the front cover 18 and a pump shell 24a of the pump impeller 24. The hydraulic power transmission chamber 28 has a hydraulic oil inlet 28i for introducing the hydraulic oil into the inside thereof and a hydraulic oil outlet 28o for discharging the hydraulic oil from the inside thereof. While the engine 12 is in operation, the hydraulic oil is always fed from the hydraulic pressure control device 50 to the hydraulic oil inlet 28i, and excess hydraulic oil is discharged from the hydraulic oil outlet 28o to the outside. In the hydraulic power transmission chamber 28, power is transmitted between the pump impeller 24 serving as an input-side hydraulic power transmission element and the turbine runner 25 serving as an output-side hydraulic power transmission element via the hydraulic oil. That is, the torque converter 23 functions as a torque amplifier by an effect of the stator 26 when a rotational speed difference between the pump impeller 24 and the turbine runner 25 is large, and functions as a fluid coupling when the rotational speed difference therebetween is small.

The torque converter 23 of the embodiment also includes a lock-up clutch 30 that can perform a lock-up operation that connects the pump impeller 24 with the turbine runner 25 and a release operation of the lock-up. The lock-up clutch 30 is structured as a multi-plate hydraulic clutch, and includes clutch plates 31 that are supported in a slidable manner by a clutch hub fixed to the front cover 18, clutch plates 32 that are supported in a slidable manner by a clutch hub connected to the turbine runner 25 via a lock-up damper 35, and a lock-up piston 33 that is arranged in an axially slidable manner inside the front cover 18 so as to be capable of pressing the clutch plates 31 and 32. The lock-up piston 33 together with the front cover 18, etc. defines a lock-up chamber 34. The lock-up chamber 34 faces the hydraulic power transmission chamber 28 with the lock-up piston 33 interposed therebetween, and has a hydraulic oil inlet 34i for introducing the hydraulic oil into the inside thereof. With this structure, if the lock-up piston 33 is moved toward the hydraulic power transmission chamber 28 by introducing the hydraulic oil into the lock-up chamber 34 via the hydraulic oil inlet 34i when a predetermined lock-up condition is satisfied after the automobile 10 has started, the clutch plates 31 and 32 are pressed together by the lock-up piston 33 and the clutch hub fixed to the front cover 18, thereby connecting the pump impeller 24 with the turbine runner 25. As a result, the power from the engine 12 can be transmitted to an input shaft 44 of the automatic transmission 40 in a mechanical and direct manner. The lock-up damper 35 absorbs a fluctuation in the torque from the pump impeller 24 side, which occurs when the lockup clutch is engaged. When the hydraulic oil is stopped from being introduced into the lock-up chamber 34, the hydraulic oil in the lock-up chamber 34 flows out of the chamber from the hydraulic oil outlet 28o of the hydraulic power transmission chamber 28, whereby the engagement of the lock-up clutch is released.

The oil pump 36 is structured as a gear pump that is provided with a pump assembly composed of a pump body and a pump cover, and an external gear connected to the pump impeller 24 of the torque converter 23 via a hub. The oil pump 36 is connected to the hydraulic pressure control device 50. By rotating the external gear with the power from the engine 12, the hydraulic oil accumulated in an oil pan (not shown) is suctioned and discharged via a strainer (not shown) by the oil pump 36. This operation makes it possible to generate hydraulic pressures required by the torque converter 23 and the automatic transmission 40, and to feed the hydraulic oil to lubrication portions such as various bearings.

The automatic transmission 40 is structured as a six-speed stepped transmission, and as shown in FIG. 2, includes a first planetary gear mechanism 41 of a single-pinion type, a second planetary gear mechanism 42 of a Ravigneaux type, and three clutches C1, C2, and C3, two brakes B1 and B2, and a one-way clutch F1 for changing a power transmission path extending from an input side to an output side. The first planetary gear mechanism 41 of a single-pinion type has a sun gear 41s serving as an external gear that is fixed to the transmission case 22, a ring gear 41r serving as an internal gear that is concentrically arranged with the sun gear 41s and connected to the input shaft 44, a plurality of pinion gears 41p meshing with the sun gear 41s and the ring gear 41r, and a carrier 41c that holds the plurality of pinion gears 41p in a rotatable and revolvable manner. The second planetary gear mechanism 42 of a Ravigneaux type has two sun gears 42sa and 42sb serving as external gears, a ring gear 42r serving as an internal gear that is fixed to an output shaft (output member) 45 of the automatic transmission 40, a plurality of short pinion gears 42pa meshing with the sun gear 42sa, a plurality of long pinion gears 42pb meshing with the sun gear 42sb, the plurality of short pinion gears 42pa, and the ring gear 42r, and a carrier 42c that holds a mutually connected set of the plurality of short pinion gears 42pa and the plurality of long pinion gears 42pb in a rotatable and revolvable manner, and is supported by the transmission case 22 via the one-way clutch F1. An output shaft 45 of the automatic transmission 40 is connected to the driving wheels DW via a gear mechanism 46 and a differential mechanism 47.

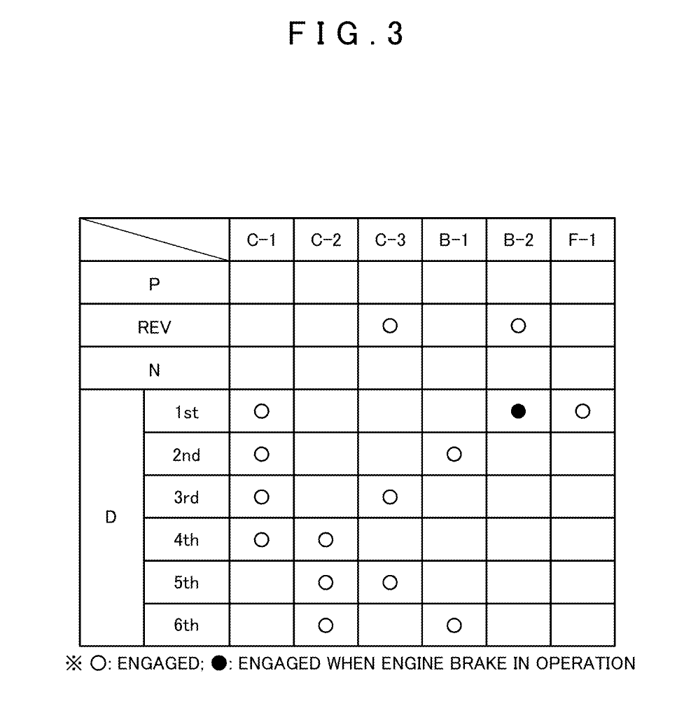

The clutch C1 is a hydraulic clutch that can engage the carrier 41c of the first planetary gear mechanism 41 with the sun gear 42sa of the second planetary gear mechanism 42, and can release the engagement. The clutch C2 is a hydraulic clutch that can engage the input shaft 44 with the carrier 42c of the second planetary gear mechanism 42, and can release the engagement. The clutch C3 is a hydraulic clutch that can engage the carrier 41c of the first planetary gear mechanism 41 with the sun gear 42sb of the second planetary gear mechanism 42, and can release the engagement. The brake B1 is a hydraulic clutch that can fix the sun gear 42sb of the second planetary gear mechanism 42 to the transmission case 22, and can release the fixation of the sun gear 42sb to the transmission case 22. The brake B2 is a hydraulic clutch that can fix the carrier 42c of the second planetary gear mechanism 42 to the transmission case 22, and can release the fixation of the carrier 42c to the transmission case 22. The clutches C1 to C3 and the brakes B1 and B2 operate in response to supply and discharge of the hydraulic oil by the hydraulic pressure control device 50. FIG. 3 shows an operation table indicating the relationship between each shift speed of the automatic transmission 40 and operating states of the clutches C1 to C3 and the brakes B1 and B2. The automatic transmission 40 provides first to sixth forward speeds and one reverse speed by placing the clutches C1 to C3 and the brakes B1 and B2 in the states indicated in FIG. 3.

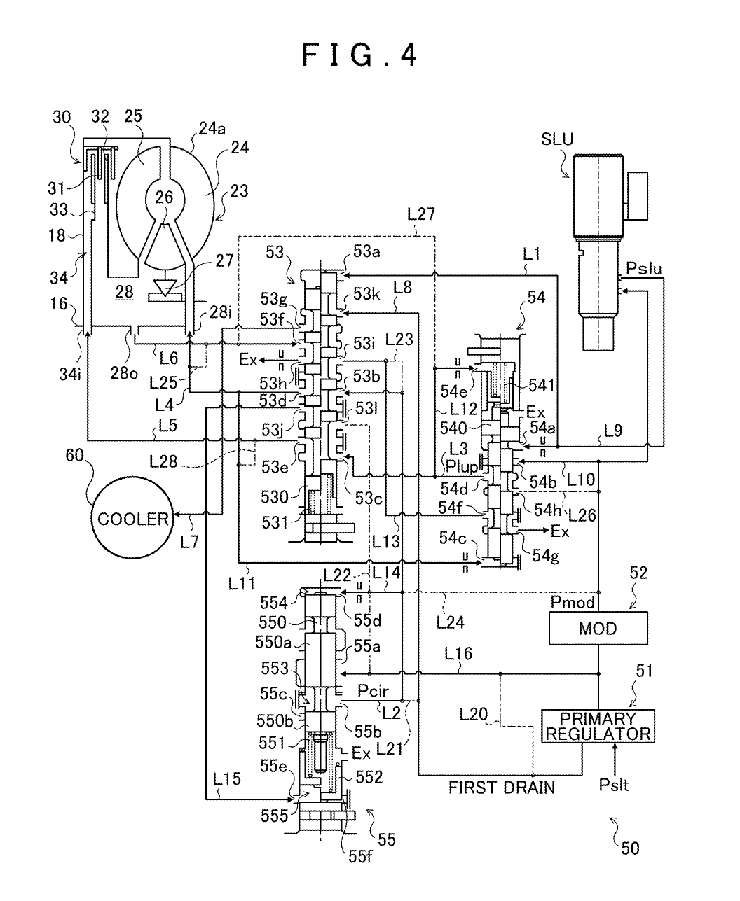

FIG. 4 is a system diagram showing an essential part of the hydraulic pressure control device 50 that supplies and discharges the hydraulic oil to and from the torque converter 23 including the lock-up clutch 30 described above, and the automatic transmission 40. The hydraulic pressure control device 50 is connected to the oil pump 36 that suctions the hydraulic oil from the oil pan (not shown) and discharges the oil by using the power from the engine 12. The hydraulic pressure control device 50 includes: a valve body (not shown) and at least one separator plate (two separator plates in the embodiment); a primary regulator valve 51 that regulates the pressure of the hydraulic oil fed from the oil pump 36 to generate a line pressure PL by being driven by a control pressure Pslt supplied from a linear solenoid valve (not shown) that regulates the pressure of the hydraulic oil fed from the oil pump 36 side (a modulator valve 52 to be described later) according to the accelerator operation amount Acc so as to output the control pressure Pslt; the modulator valve 52 that regulates the line pressure PL to generate a relatively high and constant modulator pressure Pmod; a manual valve that enables the hydraulic oil from the primary regulator valve 51 to be supplied to the clutches C1 to C3 and the brakes B1 and B2 according to the operating position of the shift lever 95, and can stop the hydraulic oil from being supplied to the clutch C1 and so on; and a plurality of linear solenoid valves (all not shown) that can regulate the pressure of the hydraulic oil (line pressure PL) from the manual valve so as to supply each regulated pressure to the corresponding one of the clutches C1 to C3 and the brakes B1 and B2. All parts, such as spools and springs, of the linear solenoid valves, the primary regulator valve 51, and the modulator valve 52 are arranged in valve holes formed in the valve body.

As shown in FIG. 4, the hydraulic pressure control device 50 also includes: a lock-up solenoid valve SLU that has a linear solenoid (not shown) under energization control by the transmission ECU 21, and that generates a lock-up solenoid pressure Pslu serving as a signal pressure for generating a lock-up pressure Plup that is obtained by regulating the modulator pressure Pmod from the modulator valve 52 and supplied to the lock-up chamber 34 when the lock-up clutch 30 is engaged (including when slip-controlled and when fully engaged); a lock-up relay valve 53 that enables the hydraulic oil to be supplied to and discharged from the hydraulic power transmission chamber 28 of the torque converter 23, and that performs, when the lock-up clutch 30 is engaged, switching of oil passages by being driven by the lock-up solenoid pressure Pslu supplied from the lock-up solenoid valve SLU; a lock-up control valve (lock-up pressure generating valve) 54 that regulates the modulator pressure Pmod supplied from the modulator valve 52 so as to generate the lock-up pressure Plup by using the lock-up solenoid pressure Pslu supplied from the lock-up solenoid valve SLU; and a circulating pressure setting valve 55 that generates a circulating pressure Pcir serving as a hydraulic pressure that is obtained by regulating (depressurizing) the line pressure PL and supplied to the hydraulic power transmission chamber 28 for operating the torque converter 23.

The lock-up relay valve 53 is a switching valve driven by the lock-up solenoid pressure Pslu supplied from the lock-up solenoid valve SLU, and is structured as a spool valve that has a spool 530 having a plurality of lands and arranged in a slidable manner in a valve hole formed in the valve body, and a spring 531 urging the spool 530 upward in the drawing. The lock-up relay valve 53 of the embodiment includes: a first input port 53a communicated with an output port of the lock-up solenoid valve SLU via oil passages L1 and L9 formed in the valve body; a second input port 53b to which the circulating pressure Pcir is supplied from the circulating pressure setting valve 55 via an oil passage L2 formed in the valve body; a third input port 53c to which the lock-up pressure Plup is supplied from the lock-up control valve 54 via an oil passage L3 formed in the valve body; a first output port 53d communicated with the hydraulic oil inlet 28i of the hydraulic power transmission chamber 28 of the torque converter 23 via an oil passage L4 formed in the valve body; a second output port 53e communicated with the hydraulic oil inlet 34i of the lock-up chamber 34 via an oil passage L5 formed in the valve body; a discharged oil inflow port 53f communicated with the hydraulic oil outlet 28o of the hydraulic power transmission chamber 28 via an oil passage L6 formed in the valve body; a first discharged oil outflow port 53g communicated with a hydraulic oil inlet of an oil cooler 60 via an oil passage L7 formed in the valve body; a second discharged oil outflow port 53h; a third discharged oil outflow port 53i; a branch port 53j communicable with the second input port 53b; a first drain input port 53k to which the hydraulic oil (first drain) drained from the primary regulator valve 51 is supplied via an oil passage L8 formed in the valve body; and a drain port 53l. Note that all the ports of the lock-up relay valve 53 are formed in the valve body (the same applies to the lock-up control valve 54 and the circulating pressure setting valve 55).

In the embodiment, the installed state (off-state) of the lock-up relay valve 53 coincides with the state shown in the right half of the valve in FIG. 4. When the lock-up solenoid valve SLU does not generate the lock-up solenoid pressure Pslu, and therefore the lock-up solenoid pressure Pslu is not supplied to the first input port 53a, the lock-up relay valve 53 is maintained in the installed state, that is, in the off-state. In the off-state as described above, the upper end in the drawing of the spool 530 comes in contact with the valve body by being urged upward in the drawing by the spring 531. Thus, the second input port 53b, the first output port 53d, and the branch port 53j are communicated with each other; the third input port 53c, the second output port 53e, and the drain port 53l are communicated with each other; the discharged oil inflow port 53f and the first discharged oil outflow port 53g are communicated with each other; and the second discharged oil outflow port 53h and the third discharged oil outflow port 53i are communicated with each other.

On the other hand, when the lock-up solenoid pressure Pslu generated by the lock-up solenoid valve SLU is supplied to the first input port 53a at the time of engaging the lock-up clutch 30, the spool 530 moves downward in the drawing against the urging force of the spring 531, thereby making the lower end of the spool 530 come in contact with a cap fixed to the valve body. Thus, the lock-up relay valve 53 changes the state thereof to the state shown in the left half of the valve in FIG. 4 (on-state). In the on-state as described above, the second input port 53b is communicated with only the first output port 53d; the third input port 53c is communicated with only the second output port 53e; the discharged oil inflow port 53f is communicated with the second discharged oil outflow port 53h and the third discharged oil outflow port 53i; the branch port 53j and the drain port 53l are communicated with each other; and the first drain input port 53k and the first discharged oil outflow port 53g are communicated with each other. Parameters, such as those of the spool (land lengths and land-to-land distances), a spring constant of the spring, and positions of the ports, of the lock-up relay valve 53 are determined so that the switching of the oil passages as described above is performed depending on whether or not the lock-up solenoid pressure Pslu is supplied to the first input port 53a.

The lock-up control valve 54 is a pressure regulating valve driven by the lock-up solenoid pressure Pslu supplied from the lock-up solenoid valve SLU, and is structured as a spool valve that has a spool 540 having a plurality of lands and being arranged in a slidable manner in a valve hole formed in the valve body, and that has a spring 541 urging the spool 540 downward in the drawing via a plunger. The lock-up control valve 54 of the embodiment includes: a first input port 54a communicated with the output port of the lock-up solenoid valve SLU via the oil passage L9 and an orifice formed in the valve body; a second input port 54b communicated, via an oil passage L10 formed in the valve body, with an output port of the modulator valve 52 that generates the modulator pressure Pmod serving as a source pressure of the lock-up pressure Plup; a third input port 54c that is communicated, via an oil passage L11 formed in the valve body, with the oil passage L4 connecting the first output port 53d of the lock-up relay valve 53 to the hydraulic oil inlet 28i of the hydraulic power transmission chamber 28, and also communicated with an oil chamber defined below an end portion of the spool 540 in the drawing not in contact with the spring 541; an output port 54d communicated with the third input port 53c of the lock-up relay valve 53 via the oil passage L3; a feedback port 54e that is communicated with the output port 54d via an oil passage L12 and an orifice formed in the valve body, and also communicated with a spring chamber in which the spring 541 is arranged; a discharged oil inflow port 54f communicated with the third discharged oil outflow port 53i of the lock-up relay valve 53 via an oil passage L13 formed in the valve body; a discharged oil outflow port 54g; and a drain port 54h.

In the embodiment, the lock-up solenoid pressure Pslu supplied to the first input port 54a acts on pressure receiving surfaces of two of the lands provided on the spool 540. In the embodiment, of these two lands, the land on the upper side in the drawing (on the spring 541 side) is set to have a pressure receiving surface (outside diameter) that is larger than any of the pressure receiving surface (outside diameter) of the land on the lower side in the drawing (on the opposite side of the spring 541), a pressure receiving surface of the spool 540 receiving a hydraulic pressure supplied to the third input port 54c, and a pressure receiving surface of the spool 540 (plunger) receiving a hydraulic pressure (feedback pressure) supplied to the feedback port 54e. Between the two lands of the spool 540 receiving the lock-up solenoid pressure Pslu, an oil chamber is defined by a difference in the pressure receiving surface areas between the two lands. This oil chamber is always communicated with the first input port 54a.

The installed state (off-state) of the lock-up control valve 54 thus structured coincides with the state shown in the right half of the valve in FIG. 4. In the installed state as described above, the lower end in the drawing of the spool 540 comes in contact with the valve body by being urged downward in the drawing by the spring 541, and thus the second input port 54b is fully closed by the spool 540, thereby cutting off the supply of the modulator pressure Pmod serving as a source pressure of the lock-up pressure Plup to the lock-up control valve 54. Accordingly, when the lock-up solenoid valve SLU does not generate the lock-up solenoid pressure Pslu, and therefore when the lock-up solenoid pressure Pslu is not supplied to the first input port 54a, the lock-up control valve 54 does not output the lock-up pressure Plup (lock-up pressure Plup=0). In addition, in the installed state, the output port 54d is communicated with the drain port 54h, and the discharged oil inflow port 54f is communicated with the discharged oil outflow port 54g.

On the other hand, when the lock-up solenoid valve SLU generates the lock-up solenoid pressure Pslu, the lock-up solenoid pressure Pslu is supplied to the first input port 54a, and moreover, because the lock-up relay valve 53 changes the state thereof to the above-described on-state along with the supply of the lock-up solenoid pressure Pslu to the first input port 53a, the circulating pressure Pcir is supplied from the first output port 53d of the lock-up relay valve 53 to the third input port 54c via the oil passage L11. Then, when the sum of a thrust force applied to the spool 540 by an action of the lock-up solenoid pressure Pslu and a thrust force applied to the spool 540 by an action of the circulating pressure Pcir exceeds the sum of the urging force of the spring 541 and a thrust force applied to the spool 540 by an action of the feedback pressure supplied to the feedback port 54e, the spool 540 moves upward in the drawing (refer to the state shown in the left half of the valve in FIG. 4), and the second input port 54b is gradually opened as the spool 540 moves. As a result, the modulator pressure Pmod supplied to the second input port 54b is regulated by the gradual opening of communication (reduction in restriction amount) between the second input port 54b and the output port 54d, thereby gradually increasing the lock-up pressure Plup output from the output port 54d.

Therefore, the lock-up pressure Plup can be gradually increased so as to be higher than the circulating pressure Pcir by gradually increasing the lock-up solenoid pressure Pslu supplied from the lock-up solenoid valve SLU. In this process, in the embodiment, the circulating pressure Pcir from the lock-up relay valve 53 is supplied to the third input port 54c of the lock-up control valve 54. Therefore, the hydraulic pressure in the hydraulic power transmission chamber 28 can be reflected to the setting of the lock-up pressure Plup made by the lock-up control valve 54, thereby setting the lock-up pressure Plup more appropriately so as to prevent a shock from occurring at the time of the engagement process of the lock-up clutch. In addition, in the embodiment, the discharged oil inflow port 54f that is communicated with the third discharged oil outflow port 53i of the lock-up relay valve 53 is kept communicated with the discharged oil outflow port 54g until the lock-up solenoid pressure Pslu supplied from the lock-up solenoid valve SLU is increased to a certain extent. Then, in the embodiment, when the lock-up solenoid pressure Pslu reaches a predetermined pressure required for full engagement of the lock-up clutch 30, the modulator pressure Pmod supplied to the second input port 54b is output without change from the output port 54d as the lock-up pressure Plup, and the spool 540 closes the discharged oil outflow port 54g to cut off the communication between the discharged oil inflow port 54f and the discharged oil outflow port 54g.

The circulating pressure setting valve 55 is a pressure regulating valve that can set the circulating pressure Pcir to one of two levels by regulating the line pressure generated by the primary regulator valve 51, and includes: a spool 550 that is arranged in an axially slidable manner in a valve hole formed in the valve body, and has at least two lands 550a and 550b provided at an axial distance from each other; a spring 551 having an end in contact with the spool 550; a plunger 552 that is arranged in an axially slidable manner in the valve hole, and is in contact with the other end of the spring 551; a pressure regulating chamber 553 for regulating the circulating pressure that is defined by the valve body and the two lands 550a and 550b of the spool 550, and is communicable with an input port 55a, an output port 55b for outputting the circulating pressure Pcir, and a drain port 55c, each of which is formed in the valve body; a feedback port 55d that is communicated with a feedback chamber (first oil chamber) 554 defined so as to face the plunger 552 with the two lands 550a and 550b of the spool 550 interposed therebetween, and is supplied with the circulating pressure Pcir output from the output port 55b to the oil passage L2 as a feedback pressure via an oil passage L14 and an orifice formed in the valve body; and a port 55e that is communicated with a circulating pressure adjusting chamber (second oil chamber) 555 defined so as to face the spring 551 with the plunger 552 interposed therebetween, and also communicated with the branch port 53j of the lock-up relay valve 53 via an oil passage L15 formed in the valve body. In the embodiment, pressure receiving surfaces of the spool 550, including all pressure receiving surfaces of the lands 550a and 550b and a pressure receiving surface for receiving the feedback pressure, have the same outside diameter. The plunger 552 is arranged, as shown in the drawing, in an axially slidable manner in an enlarged diameter portion included in the valve hole of the circulating pressure setting valve 55, and as can be understood from FIG. 4, movement of the plunger 552 in the upward direction in the drawing is restricted by an inner end portion (step portion) on the upper side in the drawing of the enlarged diameter portion.

In the circulating pressure setting valve 55 of the embodiment, the line pressure PL generated by the primary regulator valve 51 is supplied to the input port 55a via an oil passage L16 formed in the valve body, and the output port 55b is communicated with the second input port 53b of the lock-up relay valve 53 via the oil passage L2. In addition, the input port 55a of the circulating pressure setting valve 55 and the pressure regulating chamber 553 are communicated with each other via a clearance between an outer circumferential surface of the land 550a of the spool 550 and the valve body. As described above, when the lock-up solenoid valve SLU does not generate the lock-up solenoid pressure Pslu, and therefore the lock-up solenoid pressure Pslu is not supplied to the first input port 53a of the lock-up relay valve 53, the lock-up relay valve 53 is maintained in the off-state in which the branch port 53j is communicated with the second input port 53b. Accordingly, the circulating pressure Pcir is supplied from the branch port 53j of the lock-up relay valve 53 via the oil passage L15 to the port 55e of the circulating pressure setting valve 55.

On the other hand, when the lock-up solenoid pressure Pslu is generated by the lock-up solenoid valve SLU and supplied to the first input port 53a of the lock-up relay valve 53, the lock-up relay valve 53 changes the state thereof to the on-state, in which the communication between the branch port 53j and the second input port 53b is cut off, and the branch port 53j is communicated with the drain port 53l. Accordingly, the circulating pressure Pcir is not supplied from the branch port 53j of the lock-up relay valve 53 to the port 55e, that is, into the circulating pressure adjusting chamber 555, of the circulating pressure setting valve 55. When the circulating pressure Pcir is not supplied from the branch port 53j of the lock-up relay valve 53 into the circulating pressure adjusting chamber 555 as described above, the plunger 552 of the circulating pressure setting valve 55 comes in contact with a cap fixed to the valve body as shown in FIG. 4. In this state, the spool 550 is urged upward in the drawing by the spring 551.

Note that, as indicated by alternate long and two short dashed lines in FIG. 4, the valve body of the hydraulic pressure control device 50 of the embodiment is formed with: an oil passage L20 for communicating the oil passage L8 with the oil passage L16; an oil passage L21 for communicating the oil passage L2 with the oil passage L8; an oil passage L22 for communicating the oil passages L16 and L14 with the drain port 53l of the lock-up relay valve 53; an oil passage L23 for communicating the oil passage L2 with the oil passage L13; an oil passage L24 for supplying the modulator pressure to the oil passage L2; an oil passage L25 for communicating the oil passage L4 with the oil passage L6; an oil passage L26 for supplying the modulator pressure to the drain port 54h of the lock-up control valve 54; an oil passage L27 for communicating the oil passage L6 with the oil passage L12; and an oil passage L28 for communicating the oil passage L5 with the oil passage L11. It should be noted that, in the above-described embodiment, all of these oil passages L20 to L28 are closed by separator plates so as to prevent the hydraulic oil from flowing therethrough. The valve body is formed with, separately from the port 55e, a port 55f communicated with the circulating pressure adjusting chamber 555, and an oil passage for supplying to the port 55f the control pressure Pslt from the linear solenoid valve (not shown) that regulates the pressure of the hydraulic oil according to the accelerator operation amount Acc to output the pressure. Note that, in the hydraulic pressure control device 50 of the embodiment, the port 55f is closed by a separator plate as shown in the drawing.

Next, description will be made of operations of the hydraulic pressure control device 50 to supply the hydraulic pressure to the torque converter 23 including the lock-up clutch 30.

While the automobile 10 is running (while the engine 12 is operated to drive the oil pump 36), when slip-control or full engagement of the lock-up clutch 30 is not necessary, and therefore the lock-up solenoid valve SLU does not generate the lock-up solenoid pressure Pslu, that is, when the lock-up clutch 30 is disengaged, the lock-up relay valve 53 is maintained in the off-state (installed state), and the lock-up control valve 54 does not output the lock-up pressure Plup, as described above. In this case, the circulating pressure setting valve 55 regulates the line pressure PL generated by the primary regulator valve 51 so as to generate the circulating pressure Pcir serving as the hydraulic pressure supplied to the hydraulic power transmission chamber 28. Accordingly, when the lock-up clutch 30 is disengaged, the circulating pressure Pcir that is supplied from the circulating pressure setting valve 55 to the second input port 53b of the lock-up relay valve 53 in the off-state is supplied into the hydraulic power transmission chamber 28 via the first output port 53d, the oil passage L4, and the hydraulic oil inlet 28i. The hydraulic oil that has flowed through the hydraulic power transmission chamber 28 flows into the oil cooler 60 via the hydraulic oil outlet 28o, the oil passage L6, the discharged oil inflow port 53f and the first discharged oil outflow port 53g of the lock-up relay valve 53, and the oil passage L7. As described above, when the lock-up clutch 30 is disengaged, the lock-up relay valve 53 is maintained in the off-state (installed state), and the lock-up control valve 54 does not output the lock-up pressure Plup. Therefore, the hydraulic pressure is not supplied from the lock-up relay valve 53 side to the hydraulic oil inlet 34i of the lock-up chamber 34. Note that the hydraulic oil flowing out from the hydraulic oil inlet 34i of the lock-up chamber 34 is drained from the drain port 54h via the oil passage L5, the second output port 53e and the third input port 53c of the lock-up relay valve 53, the oil passage L3, and the output port 54d of the lock-up control valve 54.

The circulating pressure setting valve 55 of the embodiment that generates the circulating pressure Pcir supplied to the hydraulic power transmission chamber 28 is also supplied with the circulating pressure Pcir from the lock-up relay valve 53 into the circulating pressure adjusting chamber 555 via the oil passage L15 and the port 55e, when the lock-up clutch 30 is disengaged and the lock-up solenoid valve SLU does not generate the lock-up solenoid pressure Pslu. When the circulating pressure Pcir is supplied into the circulating pressure adjusting chamber 555 while the lock-up clutch 30 is disengaged as described above, the plunger 552 in contact with the spring 551 moves upward in the drawing (toward the feedback chamber 554 side). Accordingly, the spring 551 is compressed more when the lock-up clutch 30 is disengaged than when the circulating pressure Pcir is not supplied from the lock-up relay valve 53 into the circulating pressure adjusting chamber 555, that is, when the lock-up clutch 30 is engaged. Here, denoting as A the area of the pressure receiving surface of the spool 550 on which the circulating pressure Pcir acts as a feedback pressure, and as F the urging force of the spring 551 when the circulating pressure Pcir is supplied into the circulating pressure adjusting chamber 555 while the lock-up clutch is disengaged, the circulating pressure Pcir is expressed as Pcir=F/A. Therefore, when the plunger 552 comes in contact with the above-described end portion (step portion) of the enlarged diameter portion along with the supply of the circulating pressure Pcir to the circulating pressure adjusting chamber 555, resulting in a substantially constant compression amount of the spring 551, the value of the circulating pressure Pcir that is output from the output port 55b of the circulating pressure setting valve 55 results in a substantially constant value (a first pressure Pcir1). When the lock-up clutch 30 is disengaged, the urging force F of the spring 551 is larger, by an amount of compression of the spring 551 pressed by the plunger 552, than that when the lock-up clutch 30 is engaged, resulting in an increase in the circulating pressure Pcir by the increased amount of the urging force F of the spring 551.

On the other hand, while the automobile 10 is running (while the engine 12 is operated to drive the oil pump 36), when the lock-up solenoid valve SLU generates the lock-up solenoid pressure Pslu in order to slip-control or fully engage the lock-up clutch 30, that is, when the lock-up clutch 30 is engaged, the lock-up relay valve 53 changes the state thereof to the on-state, and the lock-up control valve 54 outputs the lock-up pressure Plup, as described above. Accordingly, when the lock-up clutch 30 is engaged, the circulating pressure Pcir that is supplied from the circulating pressure setting valve 55 to the second input port 53b of the lock-up relay valve 53 in the on-state is supplied into the hydraulic power transmission chamber 28 via the first output port 53d, the oil passage L4, and the hydraulic oil inlet 28i, and the lock-up pressure Plup that is supplied from the output port 54d of the lock-up control valve 54 to the third input port 53c of the lock-up relay valve 53 is supplied to the lock-up chamber 34 via the second output port 53e, the oil passage L5, and the hydraulic oil inlet 34i. Therefore, the engagement process (slip-control or full engagement) of the lock-up clutch 30 can be performed by controlling the lock-up solenoid valve SLU so that the lock-up pressure Plup is higher than the circulating pressure Pcir.

The hydraulic oil flowing out from the hydraulic power transmission chamber 28 of the torque converter 23 along with the engagement of the lock-up clutch 30 flows into the discharged oil inflow port 53f of the lock-up relay valve 53 via the hydraulic oil outlet 28o and the oil passage L6, and is drained from the second discharged oil outflow port 53h. The hydraulic oil is also drained from the discharged oil outflow port 54g via the third discharged oil outflow port 53i, the oil passage L13, and the discharged oil inflow port 54f of the lock-up control valve 54 until the spool 540 closes the discharged oil outflow port 54g. Then, when the lock-up solenoid pressure Pslu reaches the predetermined pressure and the lock-up clutch 30 is fully engaged, the spool 540 closes the discharged oil outflow port 54g. Accordingly, thereafter, the hydraulic oil flowing out from the hydraulic power transmission chamber 28 is drained only from the second discharged oil outflow port 53h of the lock-up relay valve 53.

Also in the case of the engagement process of the lock-up clutch 30 as described above, the circulating pressure setting valve 55 regulates the line pressure PL generated by the primary regulator valve 51 so as to generate the circulating pressure Pcir serving as the hydraulic pressure supplied to the hydraulic power transmission chamber 28. However, when the lock-up clutch 30 is engaged and the lock-up solenoid valve SLU generates the lock-up solenoid pressure Pslu, the communication between the second input port 53b and the branch port 53j is cut off by the lock-up relay valve 53 in the on-state, as described above. Therefore, the circulating pressure Pcir is stopped from being supplied into the circulating pressure adjusting chamber 555 of the circulating pressure setting valve 55. Thereby, when the lock-up clutch 30 is engaged, the plunger 552 in contact with the spring 551 does not move upward in the drawing (toward the feedback chamber 554 side), resulting in a smaller compression amount of the spring 551 than that when the lock-up clutch 30 is disengaged. Accordingly, when the lock-up clutch 30 is engaged, the urging force F of the spring 551 is smaller, by an amount reduced because the spring 551 is not compressed by the plunger 552, than that when the lock-up clutch 30 is disengaged, resulting in a reduction in the circulating pressure Pcir by the reduced amount of the urging force F of the spring 551. That is, when the compression amount of the spring 551 becomes substantially constant during engagement of the lock-up clutch 30, the value of the circulating pressure Pcir output from the output port 55b of the circulating pressure setting valve 55 coincides with a second pressure Pcir2 having a substantially constant value smaller than the first pressure Pcir1 mentioned above.

As described above, the circulating pressure setting valve 55 of the hydraulic pressure control device 50 of the embodiment has the spool 550 to which the circulating pressure Pcir is applied as a feedback pressure and the circulating pressure Pcir (another hydraulic pressure) from the lock-up relay valve 53 is applied in addition to the feedback pressure when the lock-up clutch 30 is engaged or disengaged, and also has the spring 551 that urges the spool 550. The circulating pressure setting valve 55 sets the circulating pressure to the constant first pressure Pcir1 when the lock-up clutch 30 is disengaged and to the constant second pressure Pcir2 different from the first pressure Pcir1 when the lock-up clutch 30 is engaged, depending on the force given to the spool 550 by the application of the feedback pressure and on the urging force given from the spring 551 to the spool 550.

With this structure, the circulating pressure Pcir can be set to a constant pressure of the first pressure Pcir1 or the second pressure Pcir2 in a stable manner when the lock-up clutch 30 is either disengaged or engaged, and the necessity is eliminated to finely control the linear solenoid valve according to the temperature of the hydraulic oil, for example, in the case of using a regulator valve driven by a linear solenoid valve that regulates the pressure of the hydraulic oil according to the accelerator operation amount Acc to output the control pressure Pslt so as to set the circulating pressure Pcir. In addition, by providing a different amount of the circulating pressure Pcir between when the lock-up clutch 30 is disengaged and when it is engaged, the circulating pressure Pcir when the lock-up clutch 30 is engaged can be a pressure in accordance with the mode of generation of the lock-up pressure Plup by the lock-up control valve 54. Therefore, with the hydraulic pressure control device 50 of the embodiment, it is possible to more appropriately set the hydraulic pressure in the hydraulic power transmission chamber 28 in which power is transmitted between the pump impeller 24 and the turbine runner 25 via hydraulic oil, without using complicated control.

Also, in the above-described embodiment, the lock-up control valve 54 generates the lock-up pressure Plup so as to be higher than the circulating pressure Pcir, when the lock-up clutch 30 is engaged. Thus, to the spool 550 of the circulating pressure setting valve 55, the circulating pressure Pcir (the other hydraulic pressure) from the lock-up relay valve 53 is applied so that the spring 551 is compressed more when the lock-up clutch 30 is disengaged than when the lock-up clutch 30 is engaged. With this structure, when the lock-up clutch 30 is disengaged, the circulating pressure Pcir is set to the first pressure Pcir1 that is higher, by an amount obtained by compression of the spring 551, than the second pressure Pcir2 that is set when the lock-up clutch 30 is engaged. Therefore, when the lock-up clutch 30 is disengaged, cavitation can be suppressed from occurring in the hydraulic power transmission chamber 28 by keeping the pressure in the hydraulic power transmission chamber 28 at a high level to a certain extent. When the lock-up clutch is 30 engaged, the circulating pressure Pcir is set to the second pressure Pcir2 that is lower than the first pressure Pcir1. Therefore, when the lock-up clutch 30 is engaged, both of the circulating pressure Pcir and the lock-up pressure Plup can be reduced, thereby reducing the line pressure PL serving as a source pressure of the circulating pressure Pcir and a source pressure of the modulator pressure Pmod that serves as the source pressure of the lock-up pressure Plup. Accordingly, by employing the hydraulic pressure control device 50, the lock-up clutch 30 can be engaged even in the state in which the line pressure PL is relatively low; that is, the lock-up clutch 30 can be slip-controlled and fully engaged while reducing the drive loss of the oil pump 36 that generates the source pressure of the line pressure PL. Note that, in the hydraulic pressure control device 50, the lock-up control valve 54 may generate the lock-up pressure Plup so as to be lower than the circulating pressure Pcir when the lock-up clutch 30 is engaged. In this case, the other hydraulic pressure (circulating pressure Pcir) should only be applied to the spool 550 of the circulating pressure setting valve 55 so that the spring 551 is compressed more when the lock-up clutch 30 is engaged than when the lock-up clutch 30 is disengaged.

The hydraulic pressure control device 50 further has the lock-up relay valve 53 that supplies the circulating pressure Pcir from the circulating pressure setting valve 55 to the hydraulic power transmission chamber 28 regardless of the engagement state of the lock-up clutch 30, and to supply the circulating pressure Pcir to the circulating pressure setting valve 55 when the lock-up clutch 30 is disengaged, and the circulating pressure Pcir from the lock-up relay valve 53 is applied to the spool 550 of the circulating pressure setting valve 55 when the lock-up clutch 30 is disengaged. With this structure, when the lock-up clutch is engaged, the circulating pressure setting valve 55 sets the circulating pressure Pcir to the first pressure Pcir1 that is higher than the second pressure Pcir2 by using the feedback pressure and the circulating pressure Pcir from the lock-up relay valve 53. Therefore, the circulating pressure Pcir can be set to the first pressure Pcir1 that is higher than the second pressure Pcir2 without increasing the line pressure PL more than necessary when the lock-up clutch 30 is disengaged.

In the above-described embodiment, the lock-up relay valve 53 has the discharged oil inflow port 53f that is connected to the hydraulic oil outlet 28o of the hydraulic power transmission chamber 28, and the first, the second, and the third discharged oil outflow ports 53g, 53h, and 53i, and communicates the discharged oil inflow port 53f with the first discharged oil outflow port 53g when the lock-up clutch 30 is disengaged, while communicating the discharged oil inflow port 53f with the second and the third discharged oil outflow ports 53h and 53i when the lock-up clutch 30 is engaged. In addition, the lock-up control valve 54 has the discharged oil inflow port 54f that is communicated to the third discharged oil outflow port 53i of the lock-up relay valve 53, and the discharged oil outflow port 54g, and communicates the discharged oil inflow port 54f with the discharged oil outflow port 54g until the lock-up clutch 30 is fully engaged and cut off the communication between the discharged oil inflow port 54f and the discharged oil outflow port 54g when the lock-up clutch 30 is fully engaged. With this structure, when the lock-up clutch 30 is fully engaged, unnecessary consumption of hydraulic oil can be suppressed by reducing the amount of discharge of the hydraulic oil from the hydraulic power transmission chamber 28, that is, the flow rate of the hydraulic oil circulating in the hydraulic power transmission chamber 28. Note that, in order to adjust the flow rate of the hydraulic oil circulating in the hydraulic power transmission chamber 28 when the lock-up clutch 30 is fully engaged, it is preferable to arrange an orifice for the second discharged oil outflow port 53h of the lock-up relay valve 53, as shown in FIG. 4.

Moreover, in the above-described embodiment, the circulating pressure setting valve 55 includes: the spool 550 that is arranged in an axially slidable manner in the valve hole formed in the valve body and has at least the two lands 550a and 550b provided at an axial distance from each other; the spring 551 having one end in contact with the spool 550; the plunger 552 that is arranged in an axially slidable manner in the valve hole and is in contact with the other end of the spring 551; the pressure regulating chamber 553 for regulating the circulating pressure Pcir that is defined by the valve body and the two lands 550a and 550b of the spool 550, and is communicable with the input port 55a, the output port 55b, and the drain port 55c that are formed in the valve body; the feedback chamber 554 that is defined so as to face the plunger 552 with the two lands 550a and 550b of the spool 550 interposed therebetween and is supplied with the circulating pressure Pcir output from the output port 55b as the feedback pressure; and the circulating pressure adjusting chamber 555 that is defined so as to face the spring 551 with the plunger 552 interposed therebetween and is supplied with the circulating pressure Pcir from the lock-up relay valve 53. With this structure, it is possible to set the circulating pressure Pcir to the first pressure Pcir1 when the lock-up clutch is 30 disengaged, and to the second pressure Pcir2 when the lock-up clutch 30 is engaged, without using complicated control while making the structure of the circulating pressure setting valve 55 relatively simple.

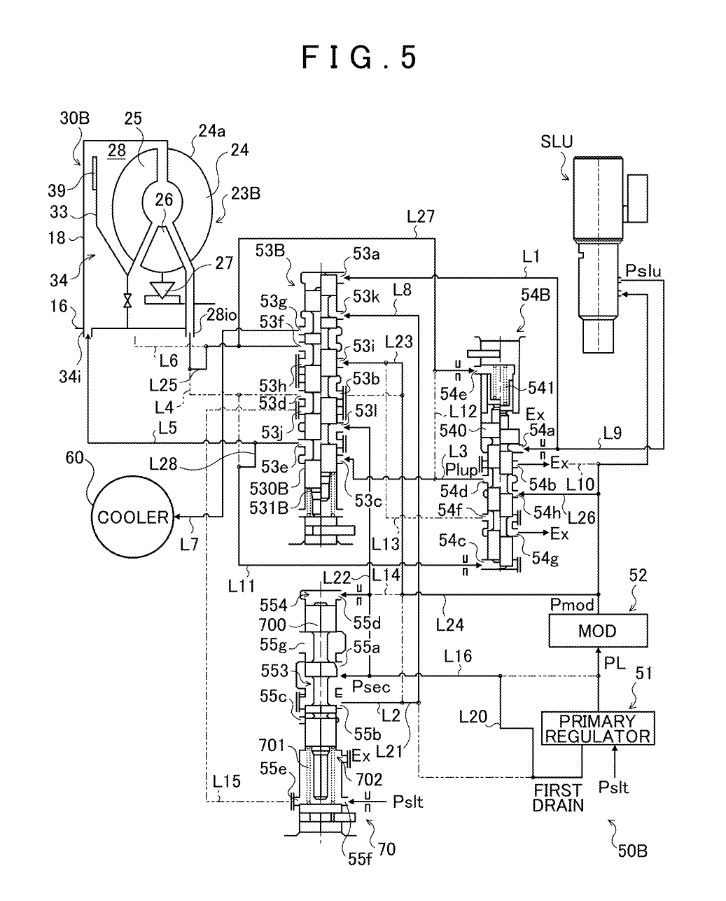

By improving arrangement of the ports and the oil passages of the valve body, shapes of the separator plates, and the like, in addition to structuring the circulating pressure setting valve 55 as described above, it is possible to easily structure, by changing the spool and the spring arranged in the valve hole of the valve body without changing the valve body, a secondary regulator valve 70 that has a spool 700 having a plurality of lands and has also a spring 701, and generates a secondary pressure Psec corresponding to the circulating pressure Pcir according to the control pressure Pslt supplied from a linear solenoid valve (not shown) that regulates the pressure of the hydraulic oil according to the accelerator operation amount Acc to output the pressure, as in a hydraulic pressure control device 50B illustrated in FIG. 5.

In the hydraulic pressure control device 50B shown in FIG. 5, an oil chamber 702 defined by the enlarged diameter portion in which the plunger 552 has been arranged is now arranged with only a spring 701 that urges the spool 700 upward in the drawing, and the port 55e and a drain port of the circulating pressure adjusting chamber 555 are closed by separator plates while the port 55f is opened to be supplied with the control pressure Pslt. In addition, the input port 55a is supplied with the first drain from the primary regulator valve 51 via a part of the oil passage L8, the oil passage L20, and a part of the oil passage L16, and the feedback port 55d is communicated with the input port 55a via a part of the oil passage L16, the oil passage L22, a part of the oil passage L14, and the orifice. Note that, in the hydraulic pressure control device 50B, the oil passages L8, L16, and L14 are closed at appropriate locations by separator plates so as to prevent the hydraulic oil from flowing through regions indicated by alternate long and two short dashed lines in FIG. 5.

In the secondary regulator valve 70 shown in FIG. 5, a pressure regulating chamber 553 is formed as a space that is defined by the valve body and two lands of the spool 700 so as to be communicated with the input port 55a and the output port 55b while being communicable with a drain port 55g formed in the valve body. That is, denoting as the secondary pressure Psec the hydraulic pressure in the pressure regulating chamber 553, as A1 the area of a pressure receiving surface that receives a hydraulic pressure supplied to the feedback port 55d of the spool 700, as A2 the area of a pressure receiving surface that receives the control pressure Pslt of the spool 700, and as F the urging force of the spring 551, a pressure regulation equation A1·Psec=A2·Pslt+F holds. Thus, the secondary regulator valve 70 generates the secondary pressure Psec corresponding to the control pressure Pslt while using, as a feedback pressure, the secondary pressure Psec supplied to the feedback chamber 554 via the oil passage L22, the feedback port 55d, etc. The secondary pressure Psec generated by the secondary regulator valve 70 is supplied as the circulating pressure to the hydraulic power transmission chamber 28 of a torque converter 23B via the oil passage L22, the lock-up relay valve 53, etc.

Here, the hydraulic pressure control device 50B shown in FIG. 5 is a device that controls the hydraulic pressures in the hydraulic power transmission chamber 28 and in the lock-up chamber 34 of the torque converter 23B that includes a single-plate type lock-up clutch 30B having a sheet of friction material 39 attached to the lock-up piston 33. The hydraulic pressure control device 50B includes a lock-up relay valve 53B and a lock-up control valve 54B that provide functions different from those of the lock-up relay valve 53 and the lock-up control valve 54 described above.

In the lock-up relay valve 53B, the first input port 53a is communicated with the output port of the lock-up solenoid valve SLU via the oil passages L1 and L9; the first drain input port 53k is communicated with the output port 55b of the secondary regulator valve 70 via a part of the oil passage L8, the oil passage L21, and a part of the oil passage L2; the third discharged oil outflow port 53i is communicated with the output port of the modulator valve 52 via a part of the oil passage L13, the oil passage L23, a part of the oil passage L2, and the oil passage L24; the second input port 53b is closed by a separator plate; the drain port 53l is communicated with the input port 55a of the secondary regulator valve 70 via the oil passage L22 and a part of the oil passage L16; and the third input port 53c is communicated with the output port 54d of the lock-up control valve 54B via the oil passage L3. Also, in the lock-up relay valve 53B, the first discharged oil outflow port 53g is communicated with the hydraulic oil inlet of the oil cooler 60 via the oil passage L7; the discharged oil inflow port 53f is communicated with a hydraulic oil inlet/outlet 28io of the hydraulic power transmission chamber 28 via a part of the oil passage L6, the oil passage L25, and a part of the oil passage L4; the second discharged oil outflow port 53h and the branch port 53j are closed by separator plates; and the second output port 53e is communicated with the hydraulic oil inlet 34i of the lock-up chamber 34 via the oil passage L5. Note that, in the hydraulic pressure control device 50B, the oil passages L2, L13, L4, and L15 are closed at appropriate locations by separator plates so as to prevent the hydraulic oil from flowing through regions indicated by alternate long and two short dashed lines in FIG. 5.

When the lock-up solenoid pressure Pslu is not supplied to the first input port 53a of the lock-up relay valve 53B, the upper end in the drawing of a spool 530B comes in contact with the valve body by being urged upward in the drawing by a spring 531B (the state shown in the right half of the valve in FIG. 5). Thus, the communication between the first drain input port 53k and the first discharged oil outflow port 53g is cut off; the third discharged oil outflow port 53i is closed by the spool 530B; the drain port 53l is communicated with the second output port 53e; and the third input port 53c is closed by the spool 530B. On the other hand, when the lock-up solenoid pressure Pslu is supplied to the first input port 53a, the spool 530B moves downward in the drawing against the urging force of the spring 531B, whereby the lower end of the spool 530B comes in contact with the cap fixed to the valve body (the state shown in the left half of the valve in FIG. 5). Thus, the first drain input port 53k is communicated with the first discharged oil outflow port 53g; the third discharged oil outflow port 53i is communicated with the discharged oil inflow port 53f; the drain port 53l is closed by the spool 530B; and the third input port 53c is communicated with the second output port 53e.

In addition, in the lock-up control valve 54B of the hydraulic pressure control device 50B, the first input port 54a is communicated with the output port of the lock-up solenoid valve SLU via the oil passage L9, etc.; the second input port 54b is used as a drain port; the modulator pressure Pmod is supplied to the drain port 54h via the oil passage L26; the feedback port 54e is communicated with the oil passage L16 (the discharged oil inflow port 53f of the lock-up relay valve 53B) via a part of the oil passage L12 and the oil passage L27; the output port 54d of the lock-up pressure Plup is communicated with the third input port 53c of the lock-up relay valve 53B via the oil passage L3; and the third input port 54c is communicated with the oil passage L5 via a part of the oil passage L11 and the oil passage L28. In the hydraulic pressure control device 50B, the oil passages L10 and L12 are closed at appropriate locations by separator plates so as to prevent the hydraulic oil from flowing through regions indicated by alternate long and two short dashed lines in FIG. 5.

When the lock-up solenoid pressure Pslu is not supplied to the first input port 54a of the lock-up control valve 54B, the lower end in the drawing of the spool 540 comes in contact with the valve body by being urged downward in the drawing by the spring 541 (the state shown in the right half of the valve in FIG. 5), and thus the drain port 54h is communicated with the output port 54d. On the other hand, when the lock-up solenoid pressure Pslu is supplied to the first input port 54a, the feedback port 54e is supplied, via the oil passage L27, etc., with the modulator pressure Pmod that is supplied to the oil passage L6 via the third discharged oil outflow port 53i and the discharged oil inflow port 53f of the lock-up relay valve 53B along with the supply of the lock-up solenoid pressure Pslu to the first input port 53a. In addition, the third input port 54c is supplied, via the oil passage L28, the oil passage L11, etc., with the lock-up pressure Plup that is supplied to the oil passage L5 via the third input port 53c and the second output port 53e of the lock-up relay valve 53B. Then, when the sum of a thrust force applied to the spool 540 by an action of the lock-up solenoid pressure Pslu and a thrust force applied to the spool 540 by an action of the lock-up pressure Plup from the third input port 54c exceeds the sum of the urging force of the spring 541 and a thrust force applied to the spool 540 by an action of the modulator pressure Pmod supplied to the feedback port 54e, the spool 540 moves upward in the drawing (the state shown in the left half of the valve in FIG. 5), and the drain port 54h is gradually closed as the spool 540 moves. As a result, the modulator pressure Pmod supplied to the drain port 54h is regulated, and the lock-up pressure Plup output from the output port 54d is gradually reduced as the lock-up solenoid pressure Pslu increases. Then, the value of the lock-up pressure Plup reaches zero when the lock-up solenoid pressure Pslu reaches a predetermined value.

Therefore, with the hydraulic pressure control device 50B structured as described above, when the lock-up clutch 30B is disengaged and the lock-up solenoid valve SLU does not generate the lock-up solenoid pressure Pslu, the spool 530B of the lock-up relay valve 53B closes the third discharged oil outflow port 53i to which the modulator pressure Pmod is supplied from the modulator valve 52 and the third input port 53c to which the lock-up pressure Plup is supplied from the lock-up control valve 54B as described above. Thus, the secondary pressure Psec generated by the secondary regulator valve 70 is supplied as the circulating pressure to the hydraulic oil inlet 34i of the lock-up chamber 34 via the drain port 53l, the second output port 53e, and the oil passage L5. Then, the hydraulic oil that has flowed through the inside of the lock-up chamber 34 and the hydraulic power transmission chamber 28 flows into the oil cooler 60 via the hydraulic oil inlet/outlet 28io, a part of the oil passage L4, the oil passage L25, a part of the oil passage L6, the discharged oil inflow port 53f and the first discharged oil outflow port 53g of the lock-up relay valve 53B, and the oil passage L7.

Also, with the hydraulic pressure control device 50B, when the lock-up clutch 30B is engaged and the lock-up solenoid valve SLU generates the lock-up solenoid pressure Pslu, the modulator pressure Pmod that is supplied to the third discharged oil outflow port 53i of the lock-up relay valve 53B is supplied into the hydraulic power transmission chamber 28 of the torque converter 23B via the discharged oil inflow port 53f, a part of the oil passage L6, the oil passage L25, a part of the oil passage L4, and the hydraulic oil inlet/outlet 28io. In addition, the lock-up pressure Plup generated so as to be gradually reduced by the lock-up control valve 54B is supplied to the lock-up chamber 34 via the third input port 53c and the second output port 53e of the lock-up relay valve 53B, the oil passage L5, and the hydraulic oil inlet 34i. That is, when the lock-up clutch 30B is engaged, the hydraulic pressure control device 50B engages the lock-up clutch 30B by supplying the modulator pressure Pmod of a constant level into the hydraulic power transmission chamber 28 while reducing the hydraulic pressure in the lock-up chamber 34. When the lock-up clutch 30B is engaged, the drain port 53l is closed by the spool 530B. Therefore, the secondary pressure Psec generated by the secondary regulator valve 70 is not supplied to the torque converter 23B.

The circulating pressure setting valve 55 of the above-described embodiment applies the circulating pressure Pcir as another hydraulic pressure in addition to the feedback pressure to the spool 550 so as to compress the spring 551 when the lock-up clutch 30 is disengaged, whereas the circulating pressure setting valve 55 does not apply the circulating pressure Pcir to the spool 550 when the lock-up clutch 30 is engaged. Consequently, the circulating pressure Pcir is set to a value that is different between when the lock-up clutch 30 is disengaged and when it is engaged. However, the circulating pressure setting valve 55 is not limited to this embodiment. For example, the circulating pressure setting valve 55 may apply another hydraulic pressure (circulating pressure Pcir) in addition to the feedback pressure to the spool 550 so as to compress the spring 551 when the lock-up clutch 30 is disengaged, whereas the circulating pressure setting valve 55 may extend the spring 551 by applying a hydraulic pressure to the spool 550 so as to offset the other hydraulic pressure (circulating pressure Pcir) when the lock-up clutch 30 is engaged, thus setting the circulating pressure Pcir to a value that is different between when the lock-up clutch 30 is disengaged and when it is engaged. Specifically, the modification mentioned above can be achieved as follows: the oil passage L2 is communicated with the port 55e of the circulating pressure setting valve 55 via an oil passage so that the circulating pressure Pcir is always supplied to the circulating pressure adjusting chamber 555; the oil passage L15 is eliminated, and the branch port 53j is closed; and a port immediately above the first output port 53d in FIG. 4 is communicated, via an oil passage, with a port (Ex) that is communicated with a spring chamber of the circulating pressure setting valve 55, thus supplying the circulating pressure Pcir to the spring chamber when the lock-up clutch 30 is engaged. The torque capacity can be increased by using a multi-plate hydraulic clutch for the lock-up clutch 30 of the torque converter 23 that is supplied with the hydraulic pressure by the hydraulic pressure control device 50; however, a single-plate hydraulic clutch may be used for the lock-up clutch 30 of the torque converter 23. In addition, the torque converter 23 that is supplied with the hydraulic pressure by the hydraulic pressure control device 50 may have two hydraulic oil inlet/outlets (omitting the hydraulic oil outlet 28o in the embodiment). Because the power transmission device 20 of the embodiment includes the torque converter 23 having the stator 26 that straightens the flow of the fluid from the turbine runner 25 to the pump impeller 24, a torque amplifying effect provided by the torque converter 23 can be used when the lock-up clutch 30 is disengaged. Alternatively, the power transmission device 20 may include a fluid coupling that does not provide a torque amplifying effect, instead of the torque converter 23 that provides the torque amplifying effect. Moreover, the hydraulic pressure control device 50 and the torque converter 23 that includes the lock-up clutch 30 may be combined with a continuously variable transmission (CVT) other than an automatic transmission.

Here, description will be made of correspondences between the main elements of the embodiment and the main elements of the present invention described in the section “Summary of the Invention”. That is, in the above-described embodiment, the hydraulic pressure control device 50 corresponds to the “hydraulic pressure control device”, where the hydraulic pressure control device 50 controls the hydraulic pressure in the hydraulic power transmission chamber 28 in which power is transmitted between the pump impeller 24 and the turbine runner 25 via hydraulic oil, and the hydraulic pressure in the lock-up chamber 34 that faces the hydraulic power transmission chamber 28 with the lock-up piston 33 included in the lock-up clutch 30 interposed therebetween. The lock-up control valve 54 corresponds to the “lock-up pressure generating valve”, where the lock-up control valve 54 generates the lock-up pressure Plup supplied to the lock-up chamber 34. The circulating pressure setting valve 55 corresponds to the “circulating pressure setting valve”, where the circulating pressure setting valve 55 has the spool 550 to which the circulating pressure Pcir is applied as a feedback pressure and the circulating pressure Pcir from the lock-up relay valve 53 serving as another hydraulic pressure is applied in addition to the feedback pressure when the lock-up clutch 30 is engaged or disengaged, and has the spring 551 that urges the spool 550, and the circulating pressure setting valve 55 sets the circulating pressure Pcir to the constant first pressure Pcir1 when the lock-up clutch 30 is disengaged and to the constant second pressure Pcir2 different from the first pressure Pcir1 when the lock-up clutch 30 is engaged, depending on the force given to the spool 550 by the application of the feedback pressure and on the urging force given from the spring 551 to the spool 550. The lock-up relay valve 53 corresponds to the “relay valve”, where the lock-up relay valve 53 supplies the circulating pressure Pcir from the circulating pressure setting valve 55 to the hydraulic power transmission chamber 28 regardless of the engagement state of the lock-up clutch 30, and supplies the circulating pressure Pcir to the circulating pressure setting valve 55 when the lock-up clutch 30 is disengaged.

However, because the embodiment is an example for specifically explaining the modes for carrying out the invention that is described in the Summary of the Invention, the correspondences between the main elements of the embodiment and the main elements of the present invention described in the Summary of the Invention do not limit the elements of the present invention described in the Summary of the Invention. In other words, the embodiment is merely a specific example of the present invention described in the Summary of the Invention, and the interpretation of the present invention described in the Summary of the Invention should be made based on the description of that section.

The modes for carrying out the invention have been described above by using an embodiment. However, the present invention is not limited to the embodiment described above in any manner, and can obviously be modified in various ways within the scope not departing from the gist of the present invention.

The present invention can be used in the manufacturing industry of hydraulic pressure control devices.

What is claimed is:

1. A hydraulic pressure control device comprising:
a circulating pressure setting valve that generates a circulating pressure serving as a hydraulic pressure supplied to a hydraulic power transmission chamber in which power is transmitted between an input-side hydraulic power transmission element and an output-side hydraulic power transmission element via hydraulic oil; and
a lock-up pressure generating valve that generates a lock-up pressure supplied to a lock-up chamber that faces the hydraulic power transmission chamber with a lock-up piston included in a lock-up clutch interposed therebetween, wherein
the hydraulic pressure control device controls the hydraulic pressures in the hydraulic power transmission chamber and in the lock-up chamber; and
the circulating pressure setting valve has a spool to which the circulating pressure is applied as a feedback pressure and another hydraulic pressure is applied in addition to the feedback pressure when the lock-up clutch is engaged or disengaged, and a spring that urges the spool, and sets the circulating pressure to a constant first pressure when the lock-up clutch is disengaged and to a constant second pressure different from the first pressure when the lock-up clutch is engaged, depending on force given to the spool by application of the feedback pressure and on urging force given from the spring to the spool.

2. The hydraulic pressure control device according to claim 1, wherein
the lock-up pressure generating valve generates the lock-up pressure so as to be higher than the circulating pressure when the lock-up clutch is engaged; and
the other hydraulic pressure is applied to the spool of the circulating pressure setting valve so that the spring is compressed more when the lock-up clutch is disengaged than when the lock-up clutch is engaged.

3. The hydraulic pressure control device according to claim 2, further comprising a relay valve that supplies the circulating pressure from the circulating pressure setting valve to the hydraulic power transmission chamber regardless of an engagement state of the lock-up clutch, and supplies the circulating pressure to the circulating pressure setting valve when the lock-up clutch is disengaged, wherein
the circulating pressure from the relay valve is applied as the other hydraulic pressure to the spool of the circulating pressure setting valve when the lock-up clutch is disengaged.

4. The hydraulic pressure control device according to claim 3, wherein
the spool of the circulating pressure setting valve is arranged in a slidable manner in an axial direction in a valve hole formed in a valve body, and has at least two lands provided at an axial distance from each other;
the spring of the circulating pressure setting valve is arranged such that one end thereof comes in contact with the spool and another end thereof comes in contact with a plunger arranged in a slidable manner in the axial direction in the valve hole;
a pressure regulating chamber for regulating the circulating pressure is defined by the valve body and the two lands of the spool, the pressure regulating chamber being communicable with an input port, an output port, and a drain port formed in the valve body;
a first oil chamber to which the circulating pressure output from the output port is supplied as the feedback pressure is defined so as to face the plunger with the two lands of the spool interposed therebetween; and
a second oil chamber to which the circulating pressure from the relay valve is supplied is defined so as to face the spring with the plunger interposed therebetween.

5. The hydraulic pressure control device according to claim 3, wherein
the hydraulic power transmission chamber has a hydraulic oil inlet through which the circulating pressure is supplied from the relay valve, and a hydraulic oil outlet for discharging the hydraulic oil;
the relay valve has a discharged oil inflow port connected to the hydraulic oil outlet of the hydraulic power transmission chamber and three discharged oil outflow ports, and communicates the discharged oil inflow port with one of the three discharged oil outflow ports when the lock-up clutch is disengaged while communicating the discharged oil inflow port with two discharged oil outflow ports other than the one of the three discharged oil outflow ports when the lock-up clutch is engaged; and
the lock-up pressure generating valve has an inflow port connected to one of the two discharged oil outflow ports of the relay valve, and an outflow port, and communicates the inflow port with the outflow port until the lock-up clutch is fully engaged and cut off communication between the inflow port and the outflow port when the lock-up clutch is fully engaged.
